(19) United States
(12) Patent Application Publication
(10) Pub. No.: US 2009/0007854 A1
(43) Pub. Date: Jan. 8, 2009

(54) Techniques for fabricating play toys for animals

(76) Inventor: John Scott Cooper, Vista, CA (US)

Correspondence Address: BRUCE L. ADAMS, ESQ., SUITE 1231, 17 BATTERY PLACE, NEW YORK, NY, 10004, US

(21) Appl. No.: 11/824,875

(22) Filed: Jul. 2, 2007

(51) Int. Cl. A01K 29/00

(52) U.S. Cl. 119/707; 87/8

(57) ABSTRACT

A play toy for animals has strands of a webbing material braided together to form at least one braided body having a pre-selected cross-sectional shape and arranged in a pre-selected structural configuration.

### BACKGROUND OF THE INVENTION

1. Field of the Invention

The present disclosure relates generally to the field of toys for pets and, more specifically, to techniques for fabricating play toys for animals using braided webbing materials.

2. Background Information

It is desirable to provide pets and, in particular, dogs, with play toys that will entertain the pet and occupy the pet's attention for extended periods of time. Generally, play toys for dogs include chew, fetch, and tug types or combinations thereof. Since such toys are treated roughly and typically carried in the animal's mouth, it is important to provide a play toy that is safe and non-hazardous to play with, bite or chew. It is especially important that the toy does not break apart or disintegrate in the dog's mouth, thus potentially injuring the dog or causing it to gag or choke.

Presently, many play toys for dogs are constructed using conventional ropes, which may have a tendency for fraying, or include filler-containing members having sewn seams. The seams are typically the weakest points of the toys and, when broken by a dog, expose embedded filler materials to the dog's teeth. Both the fraying ropes and filler materials may be hazardous to dogs. For example, fraying portions of the ropes and filler materials accumulate dirt and bacteria, which become digested by the dogs.

There is therefore a need in the art for improved techniques for fabricating toys for animals.

### SUMMARY OF THE INVENTION

Techniques for fabricating play toys for animals using braided webbing materials are described herein. In a preferred embodiment, strands of webbing material are braided together to form one or more bodies having pre-selected cross-sectional shapes, for example, substantially round or square shapes. Such bodies are arranged in a pre-selected structural configuration that may also include various biting objects, such as tennis or rubber balls, pre-formed rubber or plastic figures, and the like.

In one aspect, a play toy for animals comprises a plurality of strands of a webbing material braided together to form at least one body having a pre-selected cross-sectional shape and arranged in a pre-selected structural configuration. The cross-sectional shape of the body may be generally square, rectangular, circular, triangular, or octagonal. The webbing material comprises, for example, nylon webbing, polypropylene webbing, polyester webbing, cotton webbing, canvas webbing, or a combination thereof.

In one embodiment, the plurality of strands comprises strands of substantially flat webbing material. The strands may be four in number, for example. Each of the strands has a width in the range of from 1 to 10 mm, for example. At least a portion of the strands may have a pre-selected color pattern or a pre-selected insignia.

In another embodiment, the at least one body is provided with a filler material disposed in a space encompassed by the strands. For example, the filler material may be a fiber filler, a plastic tubing, a pre-molded structure, or a combination thereof.

In another aspect, a play toy for an animal comprises four strands of nylon webbing braided together to form at least one body having a generally square, rectangular, circular, triangular, or octagonal and arranged in a structural configuration of a chew, fetch, or tug type of the play toy, or a combination thereof. At least a portion of ends of the strands of the webbing material are braided in a manner providing fray-free terminations. The at least one body is a seamless structural unit and comprises at least one end terminated by a knot formed using a portion of the body.

In yet another aspect, a method of manufacturing a play toy for an animal comprises the steps of fabricating at least one body having a pre-selected cross-sectional shape by braiding together a plurality of strands of a webbing material, and arranging the at least one body in a pre-selected structural configuration.

In exemplary designs, the inventive techniques are used for fabricating chew, fetch, and tug types of dog toys or combinations thereof. Various aspects and embodiments of the disclosure are described in further detail below.

The foregoing summary is neither intended nor should it be construed as being representative of the full extent and scope of the present disclosure, which these and additional aspects will become more readily apparent from the detailed description, particularly when taken together with the appended drawings.

### BRIEF DESCRIPTION OF THE DRAWINGS

FIGS. 1A-1F are perspective views of a portion of a body fabricated using braided webbing materials during intermediate stages of manufacture of the body in one embodiment of the disclosure;

FIGS. 2A-2B are perspective views of a portion of a body fabricated using braided webbing materials in finished (FIG. 2A) and intermediate (FIG. 2B) stages of manufacture in another embodiment of the disclosure, and FIG. 2C is a cross-sectional view taken along the line 2C-2C in FIG. 2A;

FIGS. 3A-3B are perspective views of a body fabricated using braided webbing materials in finished (FIG. 3A) and intermediate (FIG. 3B) stages of manufacture in yet another embodiment of the disclosure, and FIG. 3C is a cross-sectional view taken along the line 3C-3C in FIG. 2A;

FIGS. 4A-4B are perspective views of a body fabricated using braided webbing materials in finished (FIG. 4A) and intermediate (FIG. 4B) stages of manufacture in still another embodiment of the disclosure, FIG. 4C is a cross-sectional view taken along the line 4C-4C in FIG. 4A, FIG. 4D is a cross-sectional view taken along the line 4D-4D in FIG. 4A, and FIG. 4E is an enlarged view of detail C in FIG. 4A;

FIGS. 5A-5B are perspective views of a body fabricated using braided webbing materials in finished (FIG. 5A) and intermediate (FIG. 5B) stages of manufacture in yet still another embodiment of the disclosure, and FIG. 5C is a cross-sectional view taken along the line 5C-5C in FIG. 5A;

FIGS. 6-8 are perspective views of exemplary play toys for a dog, which are fabricated using braided webbing materials of the present disclosure; and

FIGS. 9A-9B show another embodiment of a play toy for animals according to the present invention, where FIG. 9A is a perspective view and FIG. 9B is a cross-sectional view taken along the line 9B-9B in FIG. 9A.

### DETAILED DESCRIPTION OF THE PREFERRED EMBODIMENTS

The images in the drawings are simplified for illustrative purposes and are not depicted to scale. To facilitate understanding, identical reference numerals have been used, where possible, to designate identical elements that are common to the figures, except that suffixes may be added, when appropriate, to differentiate such elements.

The appended drawings illustrate exemplary embodiments of the disclosure and, as such, should not be considered as limiting the scope of the disclosure that may admit to other equally effective embodiments. It is contemplated that features or steps of one embodiment may be beneficially incorporated in other embodiments without further recitation.

The term “exemplary” is used herein to mean “serving as an example, instance, or illustration.” Any embodiment or design described herein as “exemplary” or “alternative” is not necessarily to be construed as preferred or advantageous over other embodiments or designs.

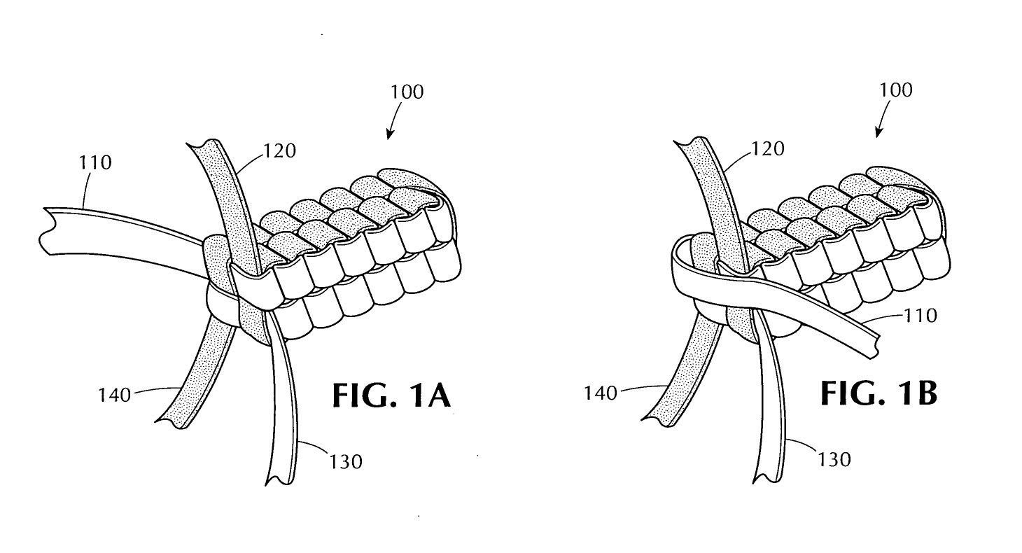

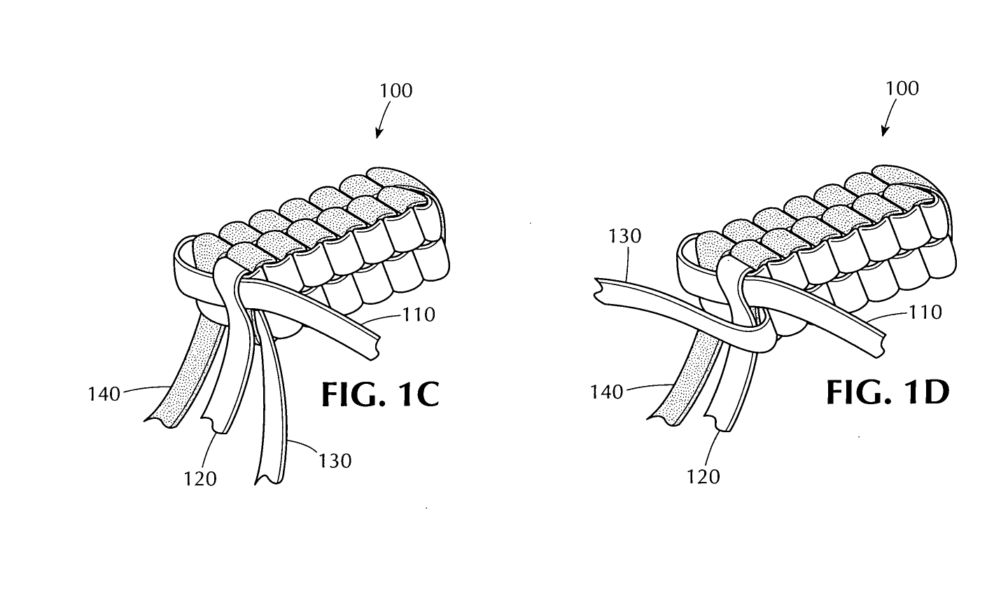

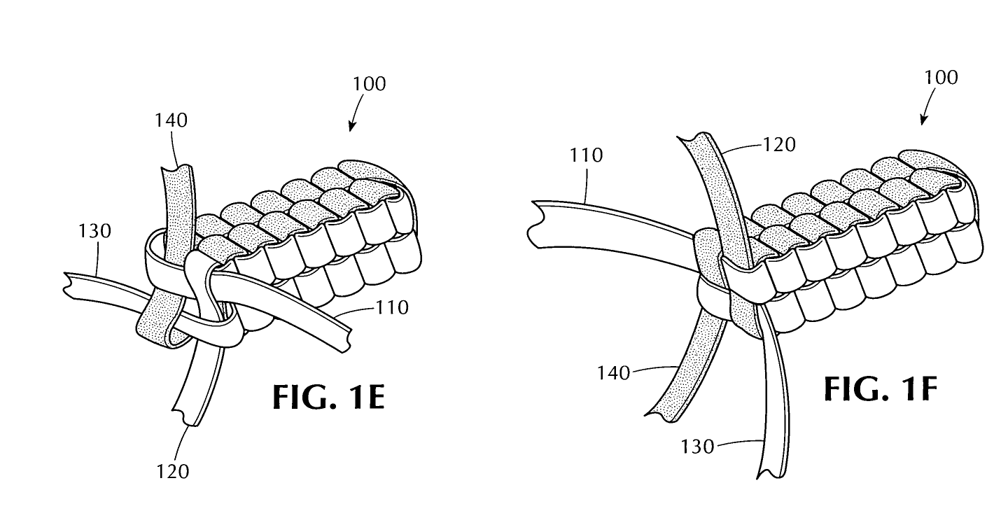

Referring to the figures, FIGS. 1A-1F depict perspective views of a portion of a body, or rope, 100 fabricated using braided webbing materials during intermediate stages of its manufacture in accordance with one embodiment of the present disclosure. The body 100 is fabricated by braiding together four strands 110, 120, 130, and 140 of substantially flat nylon webbing. Preferably, the braided flat nylon webbing has a tensile strength of from 1000 to 10,000 pounds per square inch. These strands may be braided by hand or using a corresponding braiding machine. Hereafter, the terms “body” and “rope” are used interchangeably, and the term “strand” refers a machine-woven fabric produced from respective fibers or threads.

The nylon webbing is generally produced in a form of narrow bands (for example, 1 to 10 mm width bands) of woven fabric and known for its strength, resilience to stress, and resistance to fraying. Nylon webbing is commercially available in rolls, e.g., rolls containing 50-500 meters of the respective strand. In popular applications, nylon webbing is commonly used in wide bands, such as found in car/plane seat belts and cargo straps. In the body 100, widths of the strands 110, 120, 130, and 140, as well as cross-sectional geometry of the body generally are selectively chosen to accommodate biting patterns of dogs of different size and age.

In alternative embodiments, a number of braided strands that form the rope 100 may be either greater or smaller than four, as well as at least a portion of the strands may be fabricated from polypropylene, polyester or cotton webbing, canvas strapping, or a combination thereof. In further embodiments, one or more strands of the webbing material may have pre-selected color patterns or insignia. Coloring of the respective bands may be obtained by using pre-colored component threads or by a means of printing techniques.

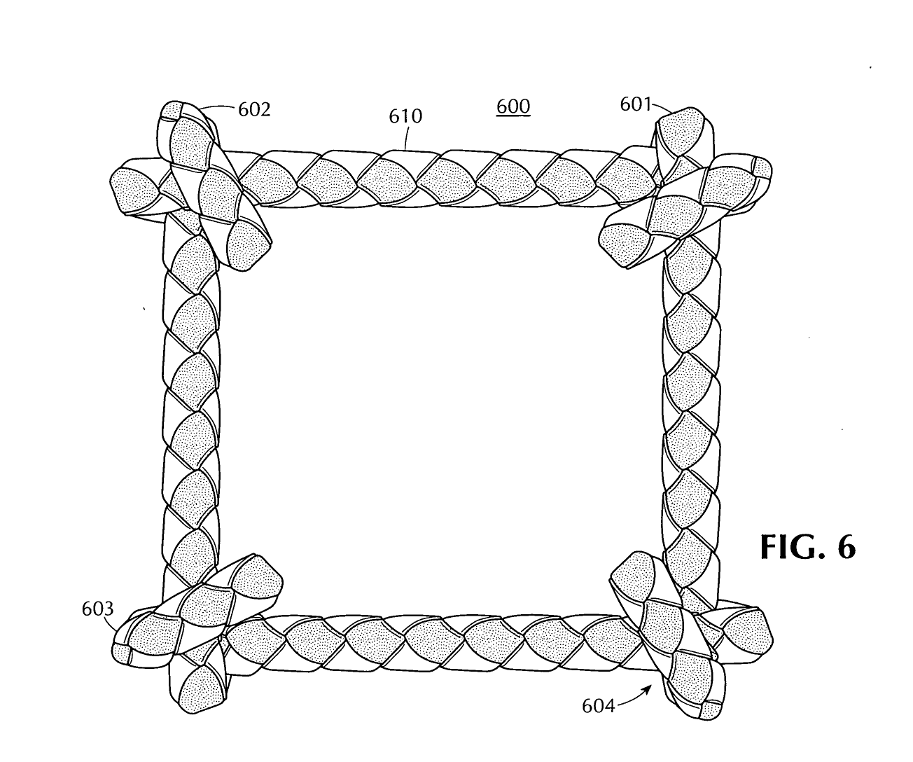

The body 100 may be braided to have a pre-selected cross-sectional shape (for example, generally square, rectangular, circular, triangular, or octagonal cross-sectional shape, and the like) and arranged in a pre-selected structural configuration, as discussed below in reference to FIGS. 6-8.

In the depicted embodiment, using the strands 110, 120, 130, and 140, the body 100 is fabricated in a sequence of steps schematically illustrated in FIGS. 1A-1F, which show consecutive positions of the strands, relative to one another, in a 6-step braiding cycle. Such cycle is repeated until a length of the body 100 attains a pre-determined value. The body 100 has a seamless structure having ends that may be furnished in a manner providing fray-free terminations. For example, loose ends of the strands 110, 120, 130, and 140 may be braided back into the body 100, braided together to form a ring-like structure, or melted, thereby forming an entirely seamless structural unit.

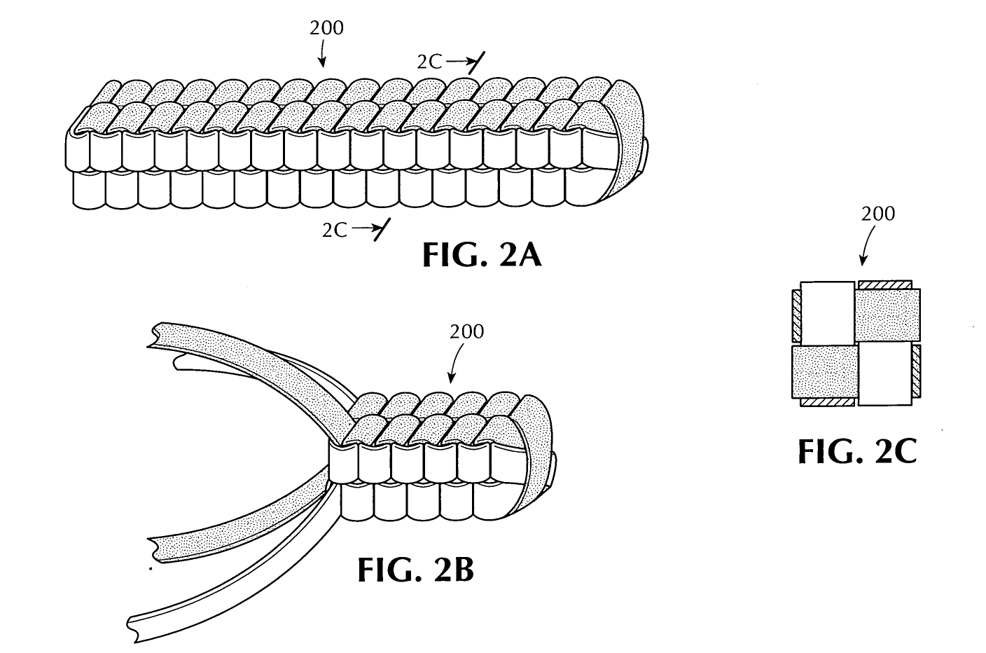

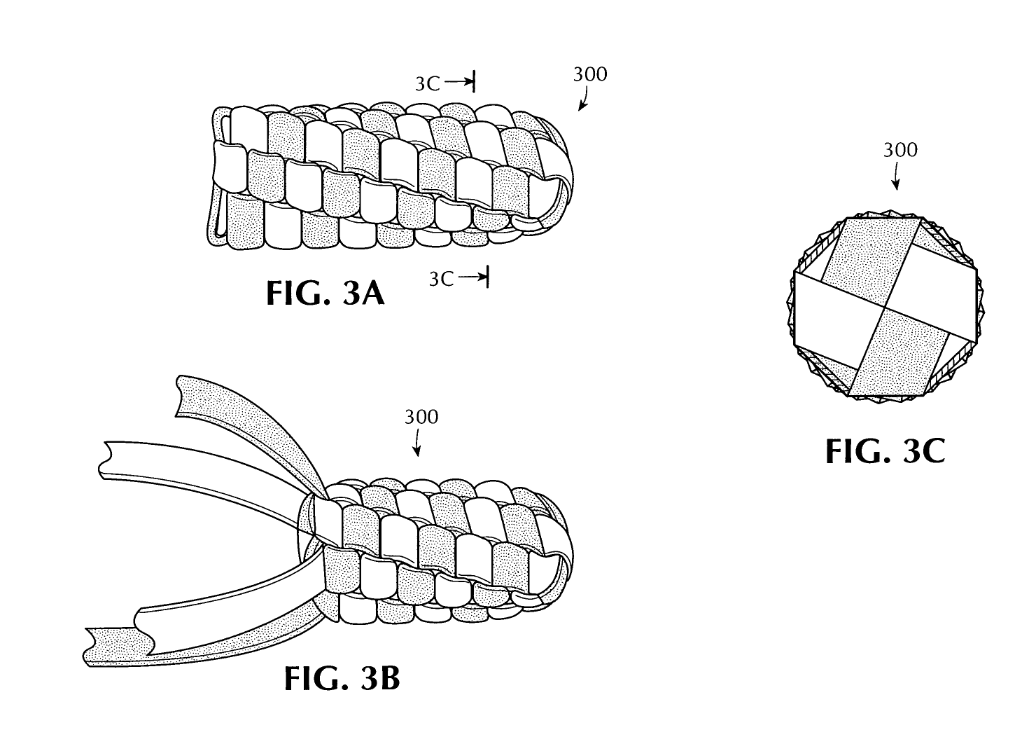

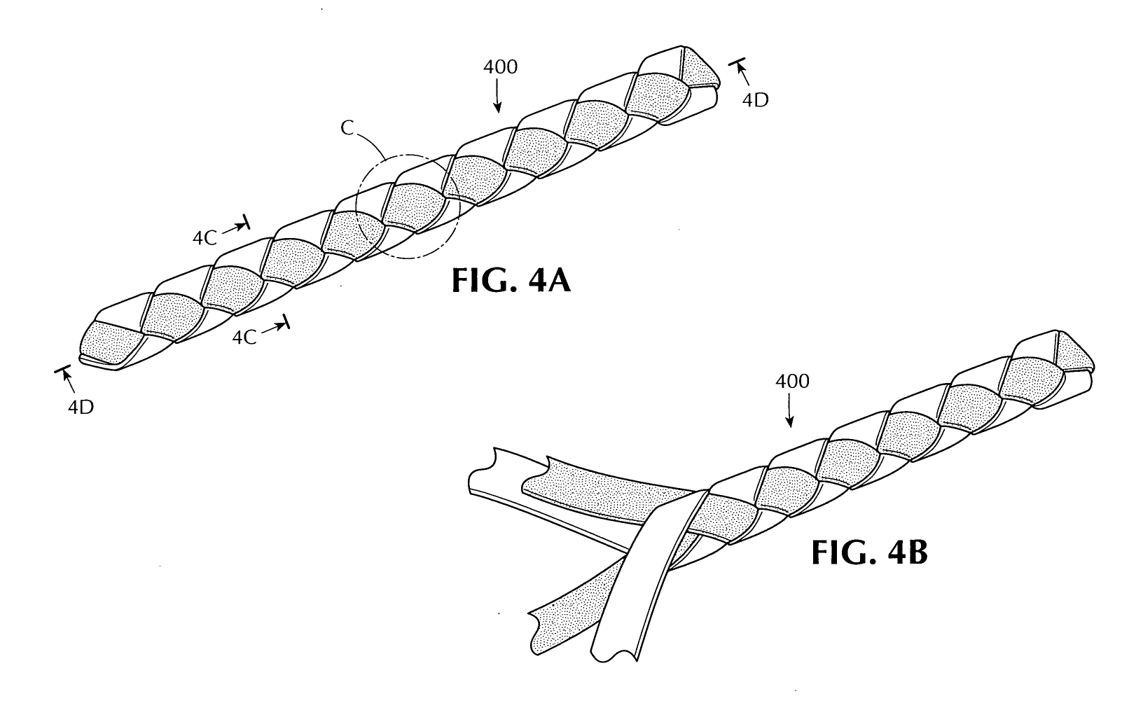

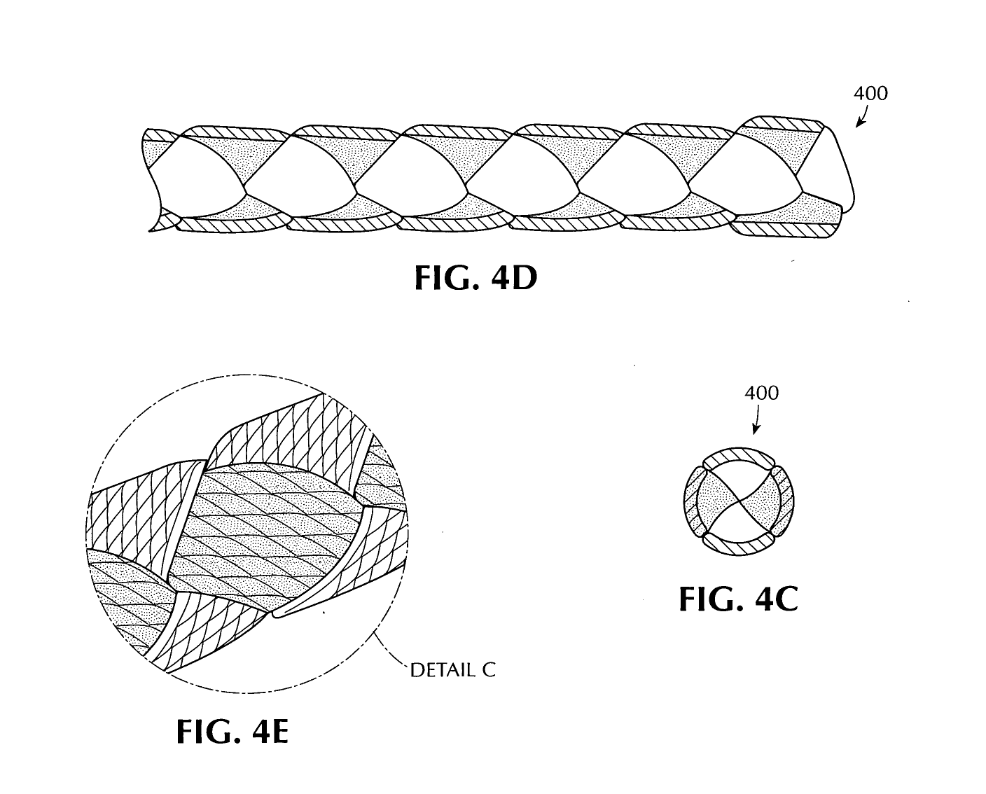

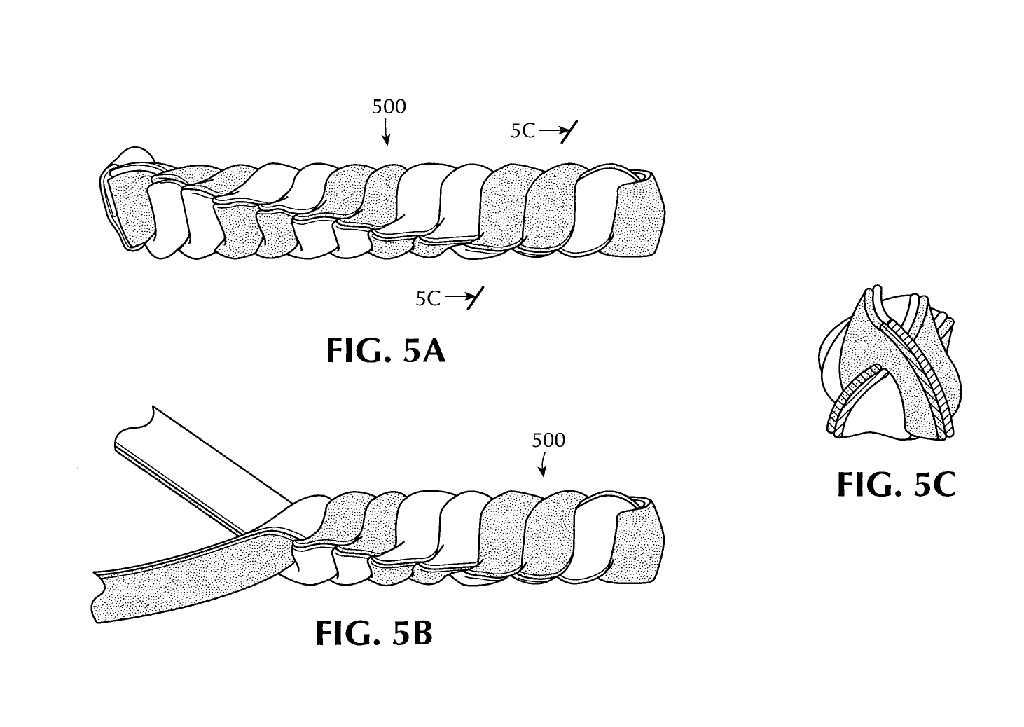

Exemplary alternative embodiment of the present disclosure are shown in FIGS. 2A-2C, 3A-3C, 4A-4E, and 5A-5C, which depict perspective views of ropes 200, 300, 400, and 500, respectively, which are shown in finished and intermediate stages of their manufacture. In particular, the ropes 200, 300, 400 are fabricated by braiding together four loose strands (e.g., see FIG. 4E corresponding to detail C in FIG. 4A), whereas in the rope 500 the strands are paired together. Those skilled in the art will readily appreciate that, using the discussed above techniques, braided ropes may be fabricated in a near unlimited variety of cross-sectional shapes.

Referring to FIG. 6, a play toy 600 is fabricated using a single braided body 610 (illustratively, rope 500), which is knotted near pre-selected points 601-603 of the body and has ends forming a knot 604. In the depicted embodiment, strands at ends of the body 610 are braided together to form a seamless ring-like body. In an alternative embodiment (not shown), strands at each end of the body 610 may be braided back into the respective end, thus forming a seamless rope-like body.

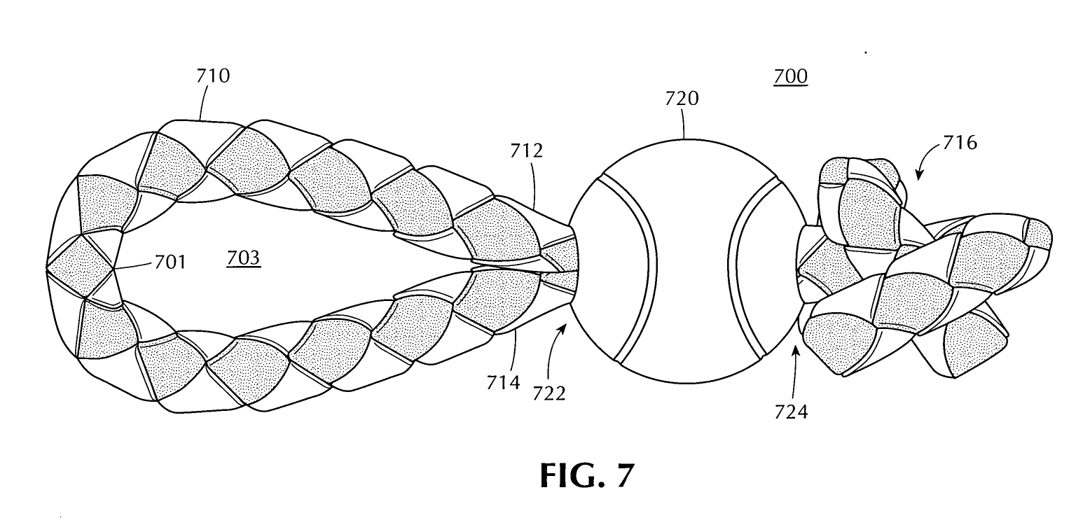

Referring to FIG. 7, a play toy 700 is fabricated using a single braided body 710 (illustratively, rope 500) and a tennis ball 720 having opposing openings 722 and 724. The body 710 is folded near a pre-selected point 701 (for example, a middle point of the body 710) to form a loop 703, which extends from the opening 722. Ends 712, 714 of the body 710 movably propagate through the tennis ball 720 and form a knot 716 near the opening 724. Strands at the knotted ends of the body 710 may be braided together to form a seamless ring-like body (as shown) or be selectively braided back into the respective ends to form a seamless rope-like body.

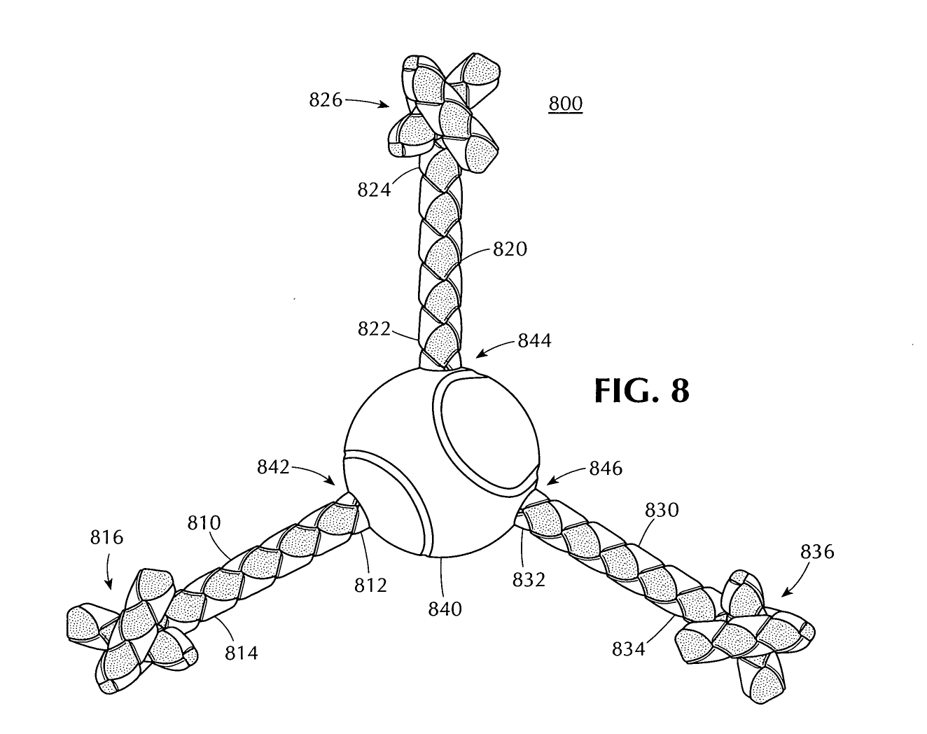

Referring to FIG. 8, a play toy 800 is fabricated using three braided bodies 810, 820, and 830 (illustratively, all of these bodies are the ropes 500) and a tennis ball 840 having openings 842, 844, and 846. First ends 812, 822, and 832 of the bodies 810, 820, and 830 are inserted into the tennis ball 840 through the openings 842, 844, and 846, respectively, and are captively retained or secured inside of the tennis ball such as by using an adhesive glue or other suitable bonding agent. Second ends 814, 824, and 834 of the bodies 810, 820, and 830 are terminated with knots 816, 826, and 836, respectively. In the depicted embodiment, strands at the knotted ends 814, 824, and 834 are selectively braided back into the respective ends, as discussed above in reference to FIGS. 6-7.

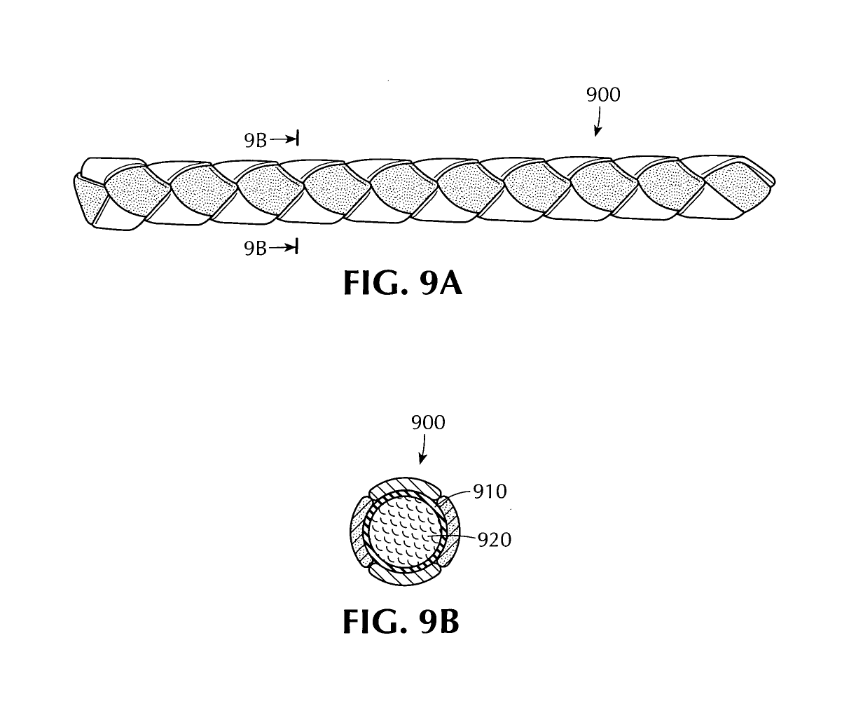

In an alternative embodiments shown in FIGS. 9A-9B, the strands may be braided over an insert 910, such as a substantially flexible plastic tubing or pre-molded structure, or otherwise encompass some inner space within the rope 900. Such inner space may further be filled with filler materials 920, including cotton, synthetic fibers, and the like.

Those skilled in the art will readily appreciate that braided ropes of the present disclosure may also be used to fabricate other types of play toys for dogs. For example, one or more braided ropes may be used to fabricate bone-shaped objects used as chew toys or disc-shaped flying objects used as fetch toys. Such play toys may also be scaled to accommodate the dogs of different age or size. In addition, the braided ropes may also be used in combination with rubber or plastic balls or other pre-formed members, as well as components made using plush, ballistic nylon, canvas, vinyl, polyvinyl chloride (PVC), and the like materials.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. A play toy for animals, comprising: a plurality of strands of a webbing material braided together to form at least one braided body having a pre-selected cross-sectional shape and arranged in a pre-selected structural configuration.

2. A play toy for animals according to claim 1; wherein the cross-sectional shape of the at least one braided body is generally square, rectangular, circular, triangular, or octagonal.

3. A play toy for animals according to claim 1; wherein the webbing material comprises nylon webbing, polypropylene webbing, polyester webbing, cotton webbing, canvas webbing, or a combination thereof.

4. A play toy for animals according to claim 1; wherein the plurality of strands comprises four strands of substantially flat webbing material, the strands having widths in a range from 1 to 10 mm.

5. A play toy for animals according to claim 1; wherein at least a portion of the strands has a pre-selected color pattern or a pre-selected insignia.

6. A play toy for animals according to claim 1; wherein at least a portion of ends of the strands are braided in a manner providing fray-free terminations.

7. A play toy for animals according to claim 1; wherein the at least one braided body is provided with a filler material disposed in a space encompassed by the strands.

8. A play toy for animals according to claim 7; wherein the filler material comprises a fiber filler, a plastic tubing, a pre-molded structure, or a combination thereof.

9. A play toy for animals according to claim 1; wherein the at least one braided body comprises a seamless structural unit.

10. A play toy for animals according to claim 1; wherein the at least one braided body comprises at least one end terminated by a knot formed using a portion of the body.

11. A play toy for animals according to claim 1; wherein the pre-selected structural configuration comprises one of a chew toy, fetch toy, or tug toy configuration or a combination thereof.

12. A play toy for animals according to claim 1; further comprising one or more biting objects attached to the at least one braided body.

13. A play toy for animals according to claim 12; wherein the biting objects are coupled to the at least one braided body and comprise one or more tennis balls, rubber balls, pre-formed rubber or plastic figures, or a combination thereof.

14. A play toy for animals according to claim 1; wherein the webbing material comprises flat nylon webbing.

15. A play toy for animals, comprising: a plurality of strands of nylon webbing braided together to form at least one braided body having a generally square, rectangular, circular, triangular, or octagonal cross-sectional shape and arranged in a structural configuration of a chew, fetch, or tug type of play toy, or a combination thereof, at least a portion of ends of the strands of the webbing material being braided in a manner providing fray-free terminations, and the at least one braided body having at least one end terminated by a knot formed using a portion of the body.

16. A play toy according to claim 15; wherein the at least one braided body comprises a seamless structural unit.

17. A play toy according to claim 15; wherein the plurality of strands comprises at least four strands.

18. A play toy according to claim 15; further comprising a biting object having a first opening and a second opening; wherein the at least one braided body is folded near a pre-selected point thereof and ends of the folded braided body extend through the first and second openings of the biting object to form at the first opening a loop encompassing the pre-selected point and are knotted near the second opening.

19. A play toy according to claim 15; further comprising a biting object having three openings; and wherein the at least one braided body comprises three braided bodies, each of the braided bodies having a first end captively retained in the biting object and a second end selectively extending through one of the openings of the biting object and terminated with a knot.

20. A method of manufacturing a play toy for an animal, comprising:
forming at least one braided body having a pre-selected cross-sectional shape by braiding together a plurality of strands of a webbing material; and
arranging the at least one braided body in a pre-selected structural configuration.

21. A method according to claim 20; wherein the at least one braided body is formed using one or more seamless fabricating techniques.

22. A method according to claim 20; wherein the at least one braided body has a cross-sectional shape selected from the group consisting of a generally square, rectangular, circular, triangular, and octagonal cross-sectional shape.

23. A method according to claim 20; wherein the webbing material comprises one of nylon webbing, polypropylene webbing, polyester webbing, cotton webbing, and canvas webbing, or a combination thereof.

24. A method according to claim 20; wherein the at least one braided body is formed using substantially flat webbing material.

25. A method according to claim 20; wherein the at least one braided body is formed using four strands of substantially flat webbing material.

26. A method according to claim 20; wherein each of the strands of substantially flat webbing material has a width in the range of from 1 to 10 mm.

27. A method according to claim 20; further comprising coloring at least a portion of the strands using a pre-selected color pattern or a pre-selected insignia.

28. A method according to claim 20; further comprising braiding at least a portion of ends of the strands to provide fray-free terminations.

29. A method according to claim 20; further comprising providing the at least one braided body with a filler material disposed in a space encompassed by the strands.

30. A method according to claim 29; wherein the filler material comprises one of a fiber filler, a plastic tubing, and a pre-molded structure, or a combination thereof.

31. A method according to claim 20; further comprising terminating the at least one braided body in a knot.

32. A method according to claim 20; further comprising providing a generally spherical-shaped biting object having a through-hole; and wherein the at least one braided body is arranged by folding the body to bring ends thereof proximate one another and passing the ends through the through-hole of the biting object and forming a knot using the ends of the body to provide the pre-selected structural configuration.

33. A method of manufacturing a play toy for an animal, comprising:
forming a plurality of braided bodies each having a pre-selected cross-sectional shape by braiding together a plurality of strands of a webbing material;
providing a biting object having a plurality of openings each corresponding to one of the braided bodies; and
inserting an end of each of the braided bodies into the respective opening of the biting object and captively retaining each of the braided bodies to the biting object.

34. A method according to claim 33; further comprising terminating an end of each of the braided bodies opposite to the end thereof that is inserted into the respective opening of the biting object using a portion of the respective body.
